(19) United States
(12) Patent Application Publication
(10) Pub. No.: US 2026/0299317 A1
(43) Pub. Date: Oct. 1, 2026

(54) AN OPHTHALMIC LENS FOR AFFECTING THE PROGRESSION OF MYOPIA AND A METHOD FOR DESIGNING THE LENS THEREOF

(71) Applicant: SHAMIR OPTICAL INDUSTRY LTD., Kibbutz Shamir (IL)

(72) Inventors: Stanley Manasseh ISAACS, Singapore (SG); Alexander SHUR, Haifa (IL); Riki ATIAS, Mishmar Hayarden (IL); Liron GLESER, Rosh Pina (IL); Noam BARAN, Kibbutz Shamir (IL); Atalia WEISS, Hoshaya (IL)

(21) Appl. No.: 18/880,402

(22) PCT Filed: Feb. 6, 2024
(86) PCT No.: PCT/IL2024/050136

§ 371 Date: Dec. 31, 2024

(30) Foreign Application Priority Data
Feb. 10, 2023 (IL) 300554

(51) Int. Cl. G02C 7/06; G02C 7/02

(52) U.S. Cl. CPC G02C 7/06; G02C 7/024

(57) ABSTRACT

The present disclosure relates to a myopia control lens including a vertical optical power profile defining a vertical canal extending along a vertical meridian of the ophthalmic lens to at least one of bottom and top boundaries thereof, the vertical canal being substantially free of distortions, creating a substantially clear vision zone. This allows a wearer to simply direct their natural gaze, without having to adjust head and posture for focusing, thereby enabling near vision at the wearer's comfortable natural posture. The lens of the present disclosure may be integrated into spectacles or may be configured as a contact lens.

### TECHNOLOGICAL FIELD

Embodiments of the presently disclosed subject matter relate generally to optical devices and more specifically to ophthalmic lenses for affecting the progression of myopia in an eye of a subject and methods for designing the lenses thereof.

### BACKGROUND

Near-sightedness, also known as myopia, is a condition of the eye where light from distant objects focuses in front of, instead of on, the retina. This causes distant objects to appear blurry by the observer, while near objects remain clear. Other symptoms may include headaches and eye strain whereas severe near-sightedness increases the risk of retinal detachment, cataracts, and glaucoma. Near-sightedness is the most common eye problem and is estimated to affect 1.5 billion people worldwide (22% of the population).

The juvenile eye typically develops until the age of 18 to 21 years, along with the progression of myopia. By the time the eye fully matures, it may become severely myopic and difficult to treat. Therefore, an effective preventive countermeasure for myopia and its progression has the potential to improve the sight of 2 to 5 billion people worldwide by 2050, according to some estimates. Current interventions to prevent juvenile myopia progression include pharmacologic agents, spectacles, and contact lenses, each with its own set of challenges. Most of the current myopia control spectacle lens designs include concentric treatment zone/s. However, the concentric treatment zone/s may give rise to compliance issues. Contact lenses and pharmacological agents are invasive and require the assistance of an adult and the use of pharmacological agents may also lead to considerable side effects.

Generally, vision involves more than the eyes. Depending on what is chosen to focus on, seeing involves tilting our head and flexing our neck, which influences the position of the entire spinal cord, and consequently the body's skeletal structure and musculature. In children, whose bones and muscles are still developing, how they habitually position their body is a particularly salient point for their future healthy development. This integral relationship between vision and posture which affects the well-being of the entire body should be considered when treating vision, and even more so in treating vision in children. Maintaining good, natural posture in children is essential for dealing with children's vision, ensuring healthy growth and preventing the potentially damaging future effects of postural disturbances.

Posture is defined as any position of the body for maintaining balance with maximum stability, minimal energy consumption, and minimal stress to anatomical structures. Dynamic posture is defined as how an individual holds his/her body during movement, and static posture refers to the body position at rest. The position of the spinal cord is a key to good posture, i.e., maintaining and not increasing the spine's three natural curves: at the neck, mid-back, and lower back. Good posture means good prevention against bone misalignment, muscle, joint and ligament strain, and the resulting fatigue and pain.

Research emphasizes the importance of proper posture, especially in children, and specifically with regard to neck flexion and eye declination. Research into postural behaviors during a variety of near vision tasks shows that children tend to develop a variety of head and eye declination combinations for these various near vision tasks. Many studies document evidence of the damaging effects of habitual high neck flexion and repetitive postural habits. Poor postural habits may affect a child's attention level and performance, with far-reaching effects on the musculoskeletal system and many aspects of general health, as well as leading to serious repercussions on future physiological development.

By misaligning the body's natural structure and thereby placing strain on various body parts, poor posture can do a great deal of damage to the body's vital systems and structures, especially when learned at a young age and maintained throughout life. Poor posture may cause additional damaging effects. In particular, incorrect posture might place an extra burden on the cardiovascular system with negative effects on the circulatory and nervous systems. Additionally, it affects blood pressure since misalignment of the cervical spine may alter blood pressure. Namely, both systolic and peripheral arterial blood pressure were higher in subjects whose posture was characterized by a forward-bent head.

Poor posture also affects attention, performance, and fatigue. A negative correlation was exhibited between posture variance and attention, while proper posture exhibited improved performance on mental math exercises among students, comparing those sitting upright and those slouching. Further, some research also indicates that improving the posture of students with learning difficulties improved their overall performance. The researchers point out that maintaining an upright, head-up posture enables a person to more easily access positive and empowering thoughts. This alleviates the fear of failure and leads to better performance.

Muscular Fatigue, including that associated with misaligned posture, degrades positive attention resources, and reduction of such muscle strain alleviates attention drain. It has also been shown that incorrect posture in children and adolescents can negatively impact their whole metabolism, including cardiopulmonary functions and the skeletal system. Schoolchildren are at special risk of suffering neck pain due to prolonged periods of static posture and poor postural habits. Neck pain can be a significant health problem for children as well as for adults. Slumped sitting with forward flexion of the head and trunk can result in increased postural tension and increased compressive force in the cervical spine, as well as changing the cervical alignment of the head and trunk relative to the lumbopelvic region. Prolonged forward neck posture leads to stress in the ligaments of the upper cervical spine, which in turn leads to fatigue and its follow-on effects.

Aside from a misaligned musculoskeletal system, poor posture can cause spinal erosion making it fragile and prone to injury, decreased flexibility of joints, disturbed balance, and increased risk of falling, with pain as the general accompanying outcome. Research indicates that poor posture even detrimentally affects digestion and case of breathing.

Given today's high usage, and from an increasingly early age, of smartphones and all manner of screens, with users typically bent over their devices, how this behavior affects body posture is especially relevant. When an individual uses his/her smartphone (e.g., typing), the lower the head is bent, the more muscle activity is generated, including the erector muscles along the length of the spinal cord, while the gravitational pull of the head increases pressure on the neck, spine, and muscles. This postural position results in a higher neck discomfort score, compared to the score of those whose head tilt is 0°, i.e., head straight rather than bent downward. Some research suggests that a prolonged neck flexion angle of 15°-20° or less, a more natural position, prevents neck discomfort. A further study showed significant differences in muscle activity at different neck flexion angles. Sustained forward flexion of the neck was shown to result in increased compressive loading on the cervical spine and a creep response in the surrounding soft tissues. In addition, the source of pain was attributed to the resulting excessive loading of the cervical and shoulder girdle muscles, especially in low-load repetitive work, such as long hours using a handheld device.

If viewing position and habitual posture have important consequences, this is doubly true for children whose immature musculoskeletal system is significantly different from that of adults, with a larger head to body ratio. This results in extra strain on children's neck muscles that have to work harder than those of adults. The relatively higher level of force on children's neck structures, including tendons, bones, and joints, can result in muscle overuse and pain. This has been verified in studies showing that when children use screens that require tilting the head downward, as opposed to screens that are placed higher allowing the head to be straight, reports of discomfort increase.

Furthermore, the weight of the head on the spine is dramatically increased when it is flexed forward and increases progressively as the head tilts further. In fact, a full-grown head weighs almost 5 kg in the neutral position. The more the head is flexed, the more the forces on the neck surge and reach more than double at 15° (roughly 12 kg). The burden of the head weight increases to 18.14 kg at 30° and to 22.23 kg at 45°, reaching a more than fivefold effect at 60° with a weight reaching 27.22 kg. In addition to the significance of neck flexion, the frequency of head bending adds to the load on neck physiology. Frequent forward flexion can result in a change to the cervical spine, curvature, supporting ligaments, tendons, musculature, and bony segments, commonly causing an undesirable postural change along with chronic pain in the neck, upper back, and associated areas.

Research has further shown that musculoskeletal neck pain, a multifactorial disease, is becoming more common in children and adolescents. Among the risk factors known to contribute to the development of this pathology are repeated movements such as bending the head, neck, and shoulders over cell phones and portable devices, and distorting the neck position while sitting, studying, or watching television, or repeated bending of the head and neck backwards to look up. These movements progressively increase stress in the cervical spine, which can result in various complications, such as premature wear, lacerations, degeneration, possible need for surgery, and developmental, medical, psychological, and social complications.

Postural discomfort and its potentially damaging effects are what should be avoided for children whose posture and musculoskeletal system are vulnerable and still developing. To avoid postural discomfort and potential damage, children need comfortable vision with spectacles that allow easy and natural eye movement during a variety of near and intermediate vision tasks in order to maintain natural, comfortable, and healthy body posture.

Studies of children's posture during a variety of near vision tasks indicate that their posture, degree of neck flexion, and lowering of their eyes vary per type of task. Even the definition of “close work” varies from task to task, as differences have been found depending on whether it is a passive task such as reading, or an active task such as writing or engaging with a tablet or smartphone. The natural eye declination was found to average between about 15-21° in various near tasks. The significance of this is that there is not one single mode of viewing for all near vision tasks. Eye direction and body posture naturally vary according to the nature of the task.

Another factor to consider with regard to children's vision and posture, is that the child's world is lower than adults, i.e., children are typically short, and they comfortably focus on things at their same height level. When they focus on the “higher” world, taller adults, objects designed for the adult world, or look up at the sky, children must typically raise their head or even bend it backwards.

Accordingly, there is a need in the art to provide myopia control lenses being designed to provide optimal vision for the full variety of natural postures across all tasks, allowing for a comfortable viewing angle to the upper part of the lens and keep head movements as minimal as possible.

### GENERAL DESCRIPTION

The present disclosure aims at providing a novel eyeglass lens (e.g., freeform lens) designed for myopia control i.e., minimizing and controlling myopia progression. The lens of the present disclosure may slow down the progression of myopia and axial elongation together with providing visual comfort and compliance. In particular, to protect children's health and well-being, the present disclosure provides a novel myopia control lens design that features a vertical canal providing the child with a substantially clear vision zone for far, intermediate and near tasks while maintaining a more comfortable and healthier posture. The unique configuration of the lens provides a good-quality vision for far, intermediate, and near distances, while ensuring comfortable and healthy posture for the wearer. The periphery of the lens incorporates a power profile with relatively more positive power compared to the central aperture, creating peripheral defocus. The unique configuration of the lens allows the child flexible and natural eye declination for near and intermediate tasks, thereby minimizing neck flexion. This innovative lens design maintains the child's natural behavior, allowing freedom of movement and comfortable usage throughout the day. Thus, the present disclosure provides an ergonomically designed lens minimizing and controlling myopia progression, while also protecting their healthy physiological development. In this connection, it should be understood that the visual experience while wearing the glasses is of crucial importance, because treatment efficacy depends on wearing time. The inventors have demonstrated that the lens of the present disclosure enables similar wearing hours compared with a control group through all waking hours. As far as known, this is one of the longest wearing time of myopia control spectacle lenses reported in clinical trials (14±1.4 hours a day including weekends). This relates to the more natural appearance and ergonomic advantage of the lens, as a result of the vertical canal design, aiming flexible vertical eye movement to any distance and eliminating the need for head and neck repositioning. This is especially helpful for today's digital lifestyle, with children spending many hours focused on close distances such as writing, reading, using smartphones, computers, etc. The unique profile of the lens is intended to minimize stress on the child's head, neck, and upper body muscles. During the clinical trial, the overall comfort score reported at 1 year was 9.07±1.6 compared to 9.38±1.1 in the control group. The remarkable similarity in comfort ratings, despite the peripheral defocus area in the lens of the present disclosure, indicates a positive visual experience for children wearing spectacles using the lens of the present disclosure.

When treating vision in children, it is imperative to take into account not only the eyes of the child but all of the abovementioned factors. Thus, the optical lens design of the present disclosure enables improving vision while taking into account how body posture is affected. The optical lens of the present disclosure allows natural posture for near tasks, especially continuous or repetitive ones. The optical lens of the present disclosure allows avoiding long-term potentially damaging effects that poor posture can have on a child.

Since the type of near vision task determines the degree to which children's eyes are lowered and the head tilted, the lens design of the present disclosure allows children visual flexibility, to enable natural body movement in near tasks.

The lens of the present disclosure allows flexibility, freedom of movement (particularly needed by children), and natural posture while optimizing vision, visual comfort, and safeguarding children's development and future well-being.

Most of the clinically tested myopia control lenses commercially available today use a concentric design, meaning that the treatment is applied all around the center of the lens. This may cause discomfort for near tasks, leading to unnatural postural adjustment, and for viewing the adult world around them, children are required to tilt their head back when looking up.

The lens of the present disclosure includes a vertical optical power profile defining a vertical canal extending along a vertical meridian of the ophthalmic lens to at least one of bottom and top boundaries thereof, the vertical canal being substantially free of distortions, creating a substantially clear vision zone. The term “boundary” hereinafter refers to the boundaries of the lens after it is cut to frame, representing a finished lens for mounting in spectacle frame. This allows the wearer (e.g., child) to simply direct their natural gaze, without having to adjust head and posture for focusing, thereby enabling near vision focus at the wearer's comfortable natural posture. It should be noted that the lens of the present disclosure may be integrated into spectacles or may be configured as a contact lens.

It should be noted that the vertical canal being substantially free of distortions and enabling clear vision zone for far, intermediate and near tasks while maintaining a more comfortable and healthier posture extends above the optical center until the very edge of the lens. It reaches higher power only in regions of the upper lens that are out of the frame. The area of the vertical canal may be considered “bound” by the 0.5 [D] of residual (unwanted) cylinder contour.

The vertical canal of the lens defines a unique shape being able to provide a balance between a substantially clear far and near vision zones and defocus treatment zones to enable myopia control. The defocus may be continuous toward the periphery so as to achieve minimal disturbance to visual experience in the vertical plane. The defocus power is applied by an addition power with a gradual profile (i.e., the addition power is a positive power induced in addition to the power needed for correcting the refractive error associated with far vision of the eye). The addition profile induced along the horizontal meridian, both temporally and nasally, starts from the center of the lens and gradually increases until it reaches about 3[D] at 30-35 deg without disturbing the overall comfort of the wearer when looking through the center area of the lens. The maximal defocus-induced additional optical power occurs in the nasal and temporal peripheries along the horizontal meridian. However, as this additional power increases along the horizontal axis, there is also a continuous additional power to a lesser extent at the bottom of the canal with no clinically significant residual cylinder power. This configuration does not interfere with the comfort of the wearer in his mid and near vision tasks. It creates an optimal balance between an adequate clear vision zone inducing wearability and effective myopia control treatment via the defocus regions.

The lens of the present disclosure provides a unique balance between an effective myopia control progression and a minimal wearer disturbance enabling longer wearing hours. The gradual increase of additional optical power has a relatively steep gradient, creating an asymmetric vertical profile with respect to the horizontal meridian, having a bottom region which may be narrower than a top region thereof. The gradual profile is adapted to mitigate and possibly eliminate the hyperopic defocus at the peripheral region(s) of the retina, preferably by introducing myopic defocus at these peripheral region(s). The myopic defocus is intended for affecting/controlling the growth of the myopic eye.

Furthermore, it should be noted that this horizontal increase in the additional power allows for reduction in lens edge thickness, resulting in more aesthetic lenses. Additionally, this horizontal increase in the additional power decreases the facial distortion through the lenses (“cut-in effect”) occurring with minus lenses. The facial distortion is the inward displacement of the face due to the prismatic effect of minus lenses. It should be noted that the aesthetic quality of the lens enhances both the comfort and adaptability of the wearer, promoting longer hours of use.

As mentioned above, the geometric configuration of the vertical canal enables to eliminate the need for head/neck repositioning, resulting in a lower-to-minimal, and comfortably natural, neck flexion angle, and a minimum of repetitive head/neck accommodative movement. The lens of the present disclosure is configured for controlling myopia progression in a subject (e.g., a young child) while minimizing stress on the child's head, neck, and upper body muscles. It protects the health of the spine, joints, and ligaments, and that means not only optimizing vision but improving attention and performance while safeguarding children's development, future health, and well-being.

The ophthalmic lens of the present disclosure is configured to: (i) correct myopia associated with the foveal region of the retina of the wearer, and (ii) effect myopic defocus in the peripheral region of the retina of the wearer, for affecting the progression of the growth of the eye of the wearer, thereby controlling the progression of myopia in the eye of the wearer. The ophthalmic lens is configured to be accommodated on wearable glasses.

The first zone of the vertical canal is disposed at the optical center of the ophthalmic lens. In this connection, it should be noted that in a single vision lens, the optical center of the lens matches the fitting point. The refractive power of the first zone is based on the myopic level of the eye of the wearer. The first zone of the vertical canal aims to correct vision as per the ophthalmic prescription. In this respect, the myopic level of the eye of the wearer is obtained, for example, by conventional myopia measurement techniques, and the refractive power of the first zone is determined based on the obtained myopic level of the eye of the wearer. Accordingly, the first zone of the vertical canal functions to correct myopia associated with the foveal region of the retina. The first zone can thus be described as an area supporting first (foveal) vision according to the wearer's prescription, and it can be reasonably defined as the area within a contour of 0.5[D] (diopter) surface astigmatism (residual cylinder), extending from the optical center to about 5 mm along the horizontal meridian. As used herein the term “about” refers to plus or minus 10 percent.

The terms “residual cylinder power” and “residual cylinder” are used throughout this disclosure to indicate the cylinder power induced at a point or an area on a surface of the lens relative to the cylinder power that is a part of the prescription (if any).

The lens has some defocus regions, substantially extending horizontally from the edges of the vertical canal and gradually increasing towards the nasal and temporal zones of the lens, which are configured for treating a patient (especially children) to mitigate myopia progression. The defocus regions have an increased optical power (positive optical power difference/change), as compared to that of the vision correction prescription. The special lens defines a power profile which is substantially symmetrical about the vertical axis (y-axis)/meridian of the ophthalmic lens, but less symmetrical about the horizontal axis (x-axis)/meridian thereof. In some possible embodiments, the power profile may be implemented/carried out on a back surface of the ophthalmic lens and the front side/surface of the lens may be spherical.

The method of designing the lens comprises inter alia obtaining the wearer's prescription (Rx) (i.e., a central refractive error of the eyes), wherein the prescription includes on-axis optical parameters including at least one of sphere power, cylinder power, axis value or prismatic power. The off-axis maximum additional power has a constant value and is not individually designed.

Specifically, the lens includes a canal shaped area being bound by the 0.5[D] residual cylinder contour defining a first optical zone aimed to enable substantially clear foveal vision, and a second optical zone with a slight additional power with a gradual profile. In this connection, it should be noted that the optical power profile of the ophthalmic lens comprises at least one defocus region at least partially surrounding the first optical zone and being configured for providing a defocus additional optical power substantially extending from the edges of the vertical canal and gradually varying in a temporal and nasal directions enabling to focus far images in front of the nasal peripheral retina and/or on the temporal peripheral retina respectively and to minimize peripheral hyperopic defocus such that the ophthalmic lens is also configured to effect myopic defocus in the peripheral region of the retina of the wearer, for affecting the growth of the eye of the wearer, thereby controlling the progression of myopia in the eye of the wearer. Since the area defined by the vertical canal is substantially free of distortions, the second optical zone of the vertical canal is also substantially free of distortions. However, this second optical zone is also a part of the defocus regions. The additional optical power is a positive power induced in addition to the power needed for correcting the refractive error of the eye. The addition profile induced along the horizontal meridian, both temporally and nasally, starts with a minimum at the center of the lens and gradually increases in both directions until it reaches about 3[D] addition at the 30-35 deg area. The vertical addition profile is induced mainly on the inferior area of the lens, and it reaches about 1[D] at about-30 deg area.

Thus, according to one broad aspect of the present disclosure there is provided an ophthalmic lens for affecting progression of myopia in an eye of an individual having a certain prescription (Rx). The lens has a smooth and clear design without any visible patterns on the lens surface. The lens includes an optical power profile defining a vertical canal having a bottom apex defining a substantially U shape extending along a vertical meridian of the ophthalmic lens to at least one of bottom and top boundaries thereof. The vertical canal being substantially free of distortions (e.g., astigmatism-related distortions). The vertical canal includes a first optical zone accommodated around the optical center of the ophthalmic lens and extending to a top boundary thereof. The first optical zone being configured for providing a first optical refractive power in accordance with a certain prescription (Rx). The vertical canal also includes a second optical zone located at the bottom apex thereof and being configured for providing a vertical additional optical power extending from the first optical zone. The optical power profile also includes at least one defocus region at least partially surrounding the first optical zone and being configured for providing a defocus additional optical power substantially extending from the edges of the vertical canal and gradually varying in a temporal and nasal directions enabling to focus far images in front of the nasal peripheral retina and/or on the temporal peripheral retina respectively and to minimize peripheral hyperopic defocus such that the ophthalmic lens is configured to: (i) correct myopia associated with the foveal region of the retina of the wearer, and (ii) effect myopic defocus in the peripheral region of the retina of the wearer, for affecting the growth of the eye of the wearer, thereby controlling the progression of myopia in the eye of the wearer.

In some embodiments, the defocus additional optical power is distributed symmetrically with respect to a vertical meridian of the ophthalmic lens and non-symmetrically with respect to a horizontal meridian thereof.

In some embodiments, the vertical canal is symmetrical with respect to the vertical meridian of the ophthalmic lens and non-symmetrical with respect to the horizontal meridian thereof. For example, the vertical canal is symmetrically located around the center point in the horizontal meridian with a width of 10 mm. The canal is bound by the 0.5[D] cylinder line, meaning that vertically it reaches about 20 deg up (about 10 mm) and about 33 degrees down (about 16 mm).

In some embodiments, the first optical zone comprises an additional power having a minimum value of about 0.01 [D] at about a 1 mm radius and an increase of about 0.1 D at about 2-3 mm radius and increase to about 0.5 D from the certain prescription (Rx) in the horizontal directions in the range of about 5-6 mm from the optical center.

In some embodiments, the vertical canal is configured to horizontally extend to about 5 mm from each side of the optical center and to vertically extend to about 10 mm above the optical center.

In some embodiments, the vertical canal comprises an area delimited by a contour of about 0.5[D] residual cylinder power extending horizontally and vertically.

In some embodiments, the vertical canal extends from the optical center to about 5 mm to each horizontal side.

In some embodiments, the residual cylinder power reaches a value of about 0.5 [D] at about 15-16 mm below the optical center along the vertical meridian.

In some embodiments, the vertical and defocus additional optical powers are distributed symmetrically with respect to the vertical meridian of the ophthalmic lens and non-symmetrically with respect to the horizontal meridian thereof.

In some embodiments, a maximal defocus additional optical power has a constant maximum value being not dependent on the individual and being not related to the vertical additional optical power.

In some embodiments, the defocus additional optical power reaches a value of about 0.5 [D] at a radial distance in the range of about 5-6 mm from the optical center along a horizontal meridian.

In some embodiments, the vertical additional optical power reaches a value of about 0.5 [D] at a radial distance in the range of about 9 mm below the optical center along a vertical meridian.

In some embodiments, the vertical additional optical power reaches a value in the range of about 0.50-1.00 [D] at a radial distance of about 9-15 mm below the optical center along a vertical meridian.

In some embodiments, the defocus additional optical power reaches a value of about 2.5 [D] at a radial distance of about 25 deg from the optical center along a horizontal meridian.

In some embodiments, the defocus additional optical power reaches a value of about 3 [D] at a radial distance in the range of about 30-35 deg from the optical center along the horizontal meridian.

In some embodiments, the optical power profile is carried out by a back surface of the lens.

According to another broad aspect of the present disclosure there is provided method for designing at least one ophthalmic lens for affecting progression of myopia, the method includes obtaining an ophthalmic prescription of a subject; configuring a vertical canal to be substantially free of distortions having a bottom apex defining a substantially U-shape and extending along a vertical meridian of the at least one ophthalmic lens to at least one of bottom and top boundaries thereof; having a first optical zone for providing a first optical refractive power in accordance with the certain prescription (Rx) of the corresponding eye and a second optical zone for providing a vertical additional optical power. The first optical zone can be accommodated about the optical center of the at least one ophthalmic lens and extends to a top boundary thereof. The second optical zone can be located at the bottom apex of the vertical canal.

In some embodiments, the method also includes measuring a certain prescription (Rx) of at least one eye.

In some embodiments, the method also includes configuring at least one defocus region at least partially surrounding the first optical zone for providing a defocus additional optical power substantially extending from the edges of the vertical canal and gradually varying in a temporal and nasal directions along the horizontal meridian to focus far images in front of the nasal peripheral retina and/or the temporal retina respectively and to minimize peripheral hyperopic defocus. The defocus additional optical power can reach a predefined maximal value at a predefined distance from the edges of the vertical canal of the at least one ophthalmic lens.

In some embodiments, the configuring the at least one defocus region comprises determining a function being indicative of a difference between the additional optical power along a vertical and horizontal meridian of the ophthalmic lens.

In some embodiments, the determining of the additional optical power further comprises applying linear fitting to the function being indicative of the difference between the additional optical power along the vertical and horizontal meridians of the ophthalmic lens.

In some embodiments, the method also includes providing a lens with the vertical canal and defocus regions.

According to yet another broad aspect of the present disclosure there is provided a processing unit for providing an individualized lens optical property profile, the processing unit comprising a data input utility being configured and operable to receive a certain prescription (Rx) of an individual, a data processing utility being configured and operable to determine an additional optical power gradually varying in a temporal and nasal directions, and a data output utility being configured and operable to provide a lens optical property profile defining a vertical canal being substantially free of distortions extending from the optical center to at least one of top and bottom boundaries thereof including a first optical zone having an optical correction according to the Rx of the eye, a second optical zone for providing a vertical gradual optical power and defocus regions for providing an additional gradual optical power.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1C show, respectively, a schematic illustration, a possible optical power addition map and a possible cylindrical power distribution map of an ophthalmic lens according to some embodiments of the present disclosure subject matter;

FIGS. 2A and 2B show, respectively, additional optical power profile over a distance from the optical center graph and the associated addition optical power gradient graph of the ophthalmic lens of FIGS. 1A-1C;

FIGS. 3A and 3B show, respectively, residual cylinder profile over a distance from the optical center graph and the associated residual cylinder gradient graph of the ophthalmic lens of FIGS. 1A-1C.

FIGS. 4A and 4B show, respectively, a possible optical power addition map and a residual cylinder map of an ophthalmic lens according to some possible embodiments of the present disclosure;

FIGS. 5A and 5B show, respectively, additional optical power profile over a distance from the optical center graph and the associated addition optical power gradient graph of the ophthalmic lens of FIGS. 4A and 4B;

FIGS. 6A and 6B show, respectively, residual cylinder profile over a distance from the optical center graph and the associated residual cylinder gradient graph of the ophthalmic lens of FIGS. 4A and 4B;

FIGS. 7A and 7B show a comparison of some optical properties for lenses of the present disclosure with different maximal additional optical power, wherein FIG. 7A shows a comparison of additional optical power difference along the horizontal and vertical meridians and FIG. 7B shows a comparison of residual cylinder power difference along the horizontal and vertical meridians;

FIGS. 8A and 8B show a comparison of a gradient profile difference along the horizontal and vertical meridians for the lenses of FIGS. 7A and 7B, wherein FIG. 8A shows a comparison of additional optical power gradient differences and FIG. 8B shows a comparison of residual cylinder power gradient differences;

FIG. 9 shows a functional flow chart of a method for designing at least one ophthalmic lens according to some possible embodiments of the present disclosure;

FIGS. 10A and 10B show a linear fit of the curves depicted in FIGS. 7A and 7B;

FIG. 11 shows a functional block diagram of a processing unit for providing an individualized lens optical property profile according to some possible embodiments of the present disclosure.

### DETAILED DESCRIPTION OF EMBODIMENTS

One or more specific and/or alternative embodiments of the present disclosure will be described below with reference to the drawings, which are to be considered in all aspects as illustrative only and not restrictive in any manner. It shall be apparent to one skilled in the art that these embodiments may be practiced without such specific details. In an effort to provide a concise description of these embodiments, not all features or details of an actual implementation are described at length in the specification. Elements illustrated in the drawings are not necessarily to scale, or incorrect proportional relationships, which are not critical. Emphasis instead being placed upon clearly illustrating the principles of the disclosure such that persons skilled in the art will be able to make and use the augmented terrestrial communication hereof, once they understand the principles of the subject matter disclosed herein. This disclosure may be provided in other specific forms and embodiments without departing from the essential characteristics described herein.

Any reference in the specification to a method should be applied mutatis mutandis to a device or system capable of executing the method and/or to a non-transitory computer-readable medium that stores instructions for executing the method. Any reference in the specification to a system or device should be applied mutatis mutandis to a method that may be executed by the system, and/or may be applied mutatis mutandis to a non-transitory computer-readable medium that stores instructions executable by the system. Any combination of any module or unit listed in any of the figures, any part of the specification, and/or any claims may be provided.

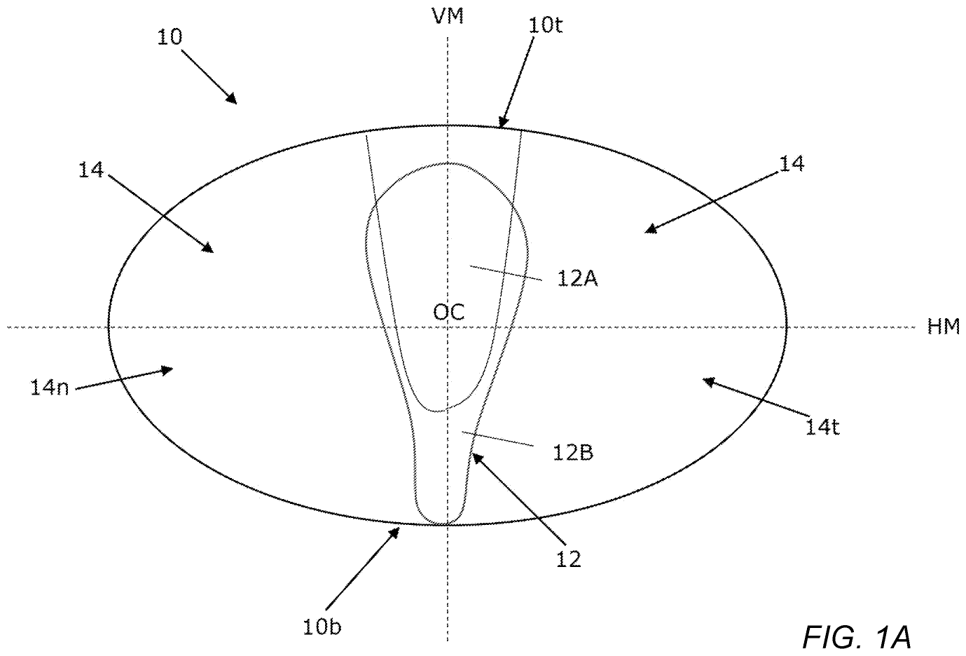

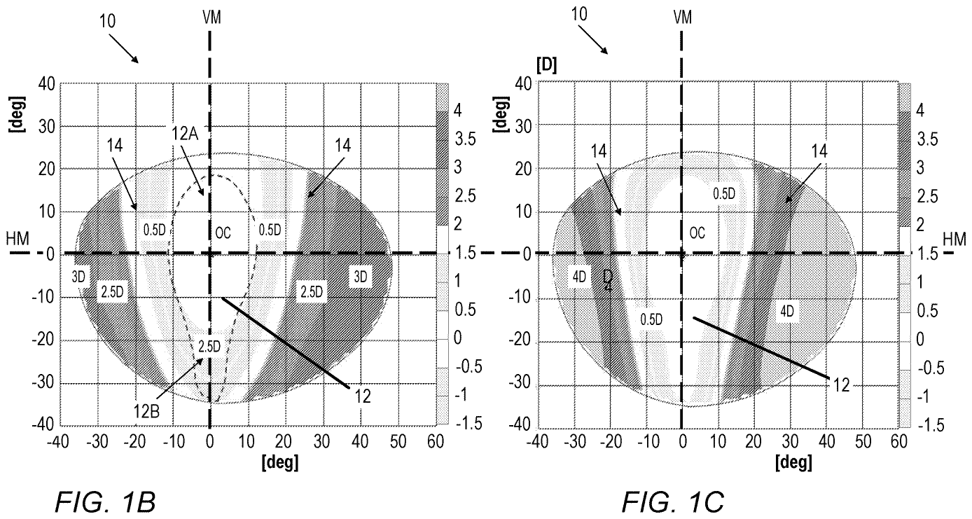

Reference is made to FIGS. 1A-1C, showing, respectively a schematic illustration (FIG. 1A), a possible optical power addition distribution map (FIG. 1B) and a possible cylinder power distribution map (FIG. 1C) of an ophthalmic lens 10 according to some embodiments of the presently disclosed subject matter. FIG. 1A illustrates a lens 10 being aimed at affecting and controlling the progression of myopia in an eye of an individual (e.g., a child) having a certain prescription (Rx). Typically, prescription (Rx) includes optical parameters including at least one of sphere power, cylinder power, axis value, add power or prismatic power. The ophthalmic lens 10 may be integrated into spectacles or a contact lens. The ophthalmic lens 10 defines a vertical meridian VM and a horizontal meridian HM intersecting at an optical center OC of the ophthalmic lens 10.

As shown, the lens 10 defines an optical power profile which defines a vertical canal 12 being configured to be substantially free of distortions having a bottom apex defining a substantially U-shape and extending along the vertical meridian VM of the ophthalmic lens 10 to at least one of bottom boundary 10b and top boundary 10t thereof. In the non-limiting example of FIGS. 1A-1C, the vertical canal 12 vertically extends 30 deg (15-16 mm) to the bottom boundary 10b of the ophthalmic lens 10, about 20 deg (9-mm) to the top boundary 10t of the lens, and horizontally about 10 deg (5-6 mm) from the optical center OC to the nasal side and 10 deg (5-6 mm) from the optical center OC to the temporal side, defining a width of about 10 mm. The vertical canal 12 is configured to be substantially free of distortions, namely below clinically significant residual (unwanted) cylinder power. Generally, the vertical canal 12 may have a residual cylinder at its periphery, however this residual cylinder is below an astigmatic sensitivity threshold (about 0.5 D) of the eye and therefore does not cause inconvenience to the user. This way, the vertical canal 12 is configured to enable the individual (e.g., a child) to adopt his/her natural posture, i.e., minimizing a need for head, neck, or upper body muscles repositioning. As best seen in FIG. 1C, the vertical canal 12 can have an area which is delimited by a residual cylinder contour/isoline of 0.5 [D].

The vertical canal 12 defines a first optical zone 12A being bound by a 0.5 [D] residual cylinder contour, as described above. As best seen in FIGS. 1A and 1B, the vertical canal 12 can have a first optical zone which is delimited by a residual cylinder contour/isoline of 0.5 [D]. As clearly shown in FIGS. 1A and 1B, the vertical canal 12 comprises the first optical zone 12A, accommodated about the optical center OC and extending about 20 deg (about 9-10 mm) from the optical center OC to the top boundary 10t and about 18-20 deg (about 9-10 mm) below the optical center OC. The first optical zone 12A is configured for providing an optical refractive power in accordance with the prescription (Rx) of the wearer to thereby support central vision of the wearer. The vertical canal 12 also defines a second optical zone 12B extending from the first optical zone 12A and provides a gradual increase of vertical additional power. More specifically, the second optical zone 12B includes a slight increase in optical power (0.5D-1.00D) from about −20 deg to −30 deg (9 mm-15 mm) below the optical center OC. Optionally, and in some embodiments preferably, the vertical canal 12 is substantially symmetrical with respect to a vertical meridian VM of the ophthalmic lens and non-symmetrical or asymmetrical with respect to a horizontal meridian HM thereof. For example, the relative additional power gradually increases horizontally until it reaches 3.00[D] at about 16 mm from the optical center of the lens whereas vertically it reaches 1.00[D] at about 15 mm below the optical center of the lens along the vertical meridian. Depending on the frame size, the relative additional power at the inferior rim ranges from 1.00 to 1.50D.

The optical power profile of the lens 10 also defines defocus regions 14 at least partially surrounding the first optical zone 12A. The defocus regions 14 extend to boundaries/edges of the ophthalmic lens 10 defining a nasal peripheral zone 14n and a temporal peripheral zone 14t. The defocus regions 14 are configured for providing a defocus additional optical power P, relative to the prescription power. The defocus additional power P can gradually increase towards the temporal and nasal directions towards boundaries of the ophthalmic lens 10 enabling to focus far images/objects in front of the nasal peripheral retina and/or the temporal retina respectively and to minimize peripheral hyperopic defocus.

In the non-limiting example of FIG. 1B, the defocus additional optical power P at the nasal and temporal peripheries of the defocus regions 14 reaches a maximum of about 3.00[D] relative to the prescription power. However, the lens 10 may generally be designed with higher or lower maximal defocus additional optical power P. The purpose of the defocus regions 14 of the ophthalmic lens 10 is to affect myopic defocus in the peripheral regions of the retina. The defocus additional optical power P of the defocus regions 14 is intended to eliminate peripheral hyperopic defocus as much as possible, preferably by inducing myopic defocus. The purpose of affecting the myopic defocus in the peripheral regions of the retina is to affect/control the growth of the myopic eye, which controls the progression of myopia in the eye. As such, the defocus regions 14 are not intended to correct myopia or hyperopia associated with the peripheral region of the retina.

This special configuration of the ophthalmic lens 10 enables to: (i) correct myopia associated with the foveal region of the retina of the subject/wearer, and (ii) effect myopic defocus in the peripheral regions of the retina of the wearer, for affecting the growth of the eye of the wearer, thereby affecting the progression of myopia in the eye of the wearer.

The first optical zone 12A can have an area (width) of about 10-12 mm, i.e., which extends horizontally (along the horizontal meridian HM) 5 mm-6 mm from the optical center OC in the nasal and temporal directions. In some embodiments, the first optical zone 12A accommodates the prescription of the wearer (Rx) at about the optical center of the lens, having a minimum addition of 0.01 [D] at a 1 mm radius and increasing to about 0.1 D from the prescription power at about 2-3 mm from the optical center OC and increasing to about 0.5 D addition at about 5-6 mm temporally and nasally from the optical center OC along the horizontal meridian HM. The vertical additional optical power, at the second optical zone 12B, can reach a value of about 0.5 [D] at a radial distance in the range of about 9 mm-10 mm below the optical center OC along the vertical meridian VM and reaches a value of about 1.00 [D] at a radial distance of about 30deg (about 15 mm) below the optical center OC along the vertical meridian VM.

In some embodiments, the defocus additional optical power P reaches a value of about 2.5 [D] at a radial distance in the range of about 25-26 deg (about 12 mm-13 mm) from the optical center along the horizontal meridian HM temporally and nasally and a value of about 3[D] at a radial distance in the range of about 30-32 deg (about 15 mm-16 mm) from the optical center along the horizontal meridian HM.

FIGS. 1B and 1C map the variations of, respectively, the additional optical power and the residual cylinder across the field of view (FOV) of the wearer (within the spectacle frame). Therefore, the maps are divided by horizontal and vertical lines representing angles/eye rotations [in deg] from the center of the FOV, which generally substantially coincides/aligned with the optical center of the lens. The various isolines/contours correspond to different additional optical powers (FIG. 1B) and different residual cylinder powers (FIG. 1C). In FIG. 1C, the area of the vertical canal 12 is located within the innermost isoline corresponding to residual cylinder of about 0.5D. The residual cylinder progressively increases, nasally and temporally to about 4D. In FIG. 1B, the additional optical power is about 0.5D (innermost isoline) and progressively increases to about 3D at the nasal and temporal peripheries of the lens 10. As shown, the first optical zone 12A almost reaches the upper boundary of the lens. The vertical canal 12 is illustrated in FIG. 1B by the dashed line. This configuration enables a substantially clear vision for far, mid and near vision tasks. The main defocus regions reaching an additional power of 3[D] are on the nasal and temporal sides along the horizontal axis.

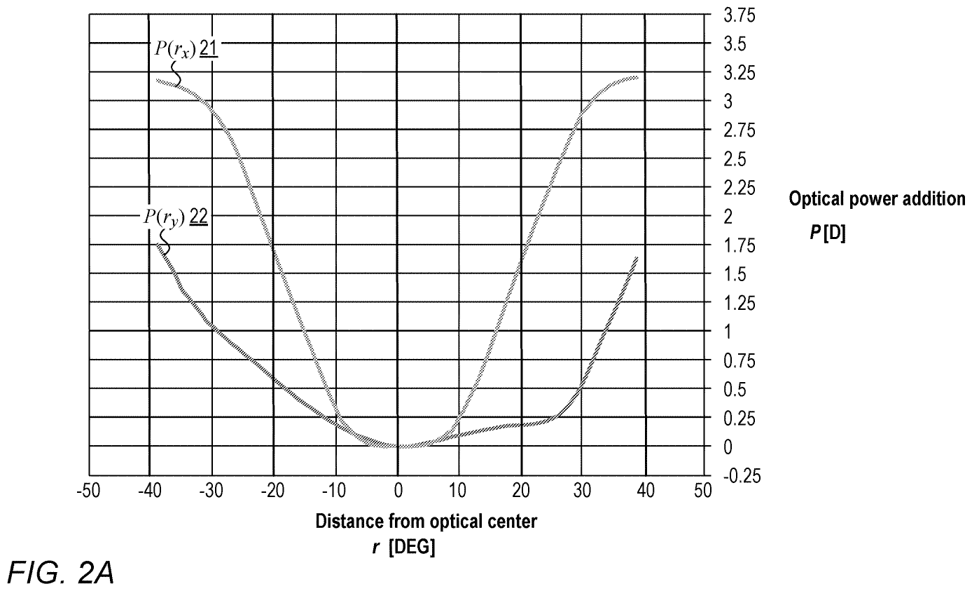

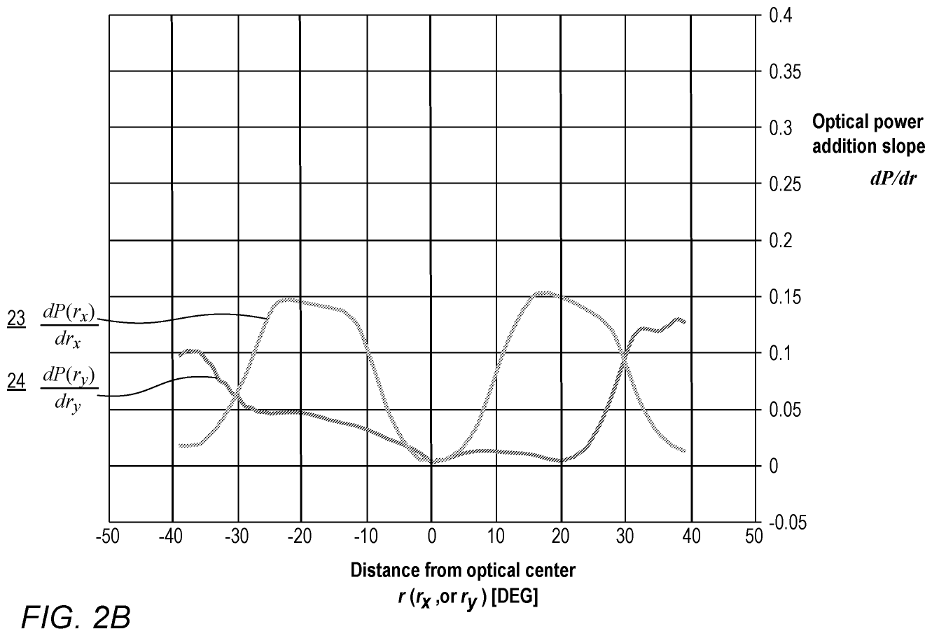

Reference is made to FIGS. 2A and 2B graphically illustrating, respectively, the additional optical power P [D] (vertical and horizontal profiles) as a function of (radial) distance r [deg] from the optical center (OC in FIGS. 1A-1C) of the ophthalmic lens 10 of FIGS. 1A-1C and the associated additional optical power slope (gradient)

$$\frac{\partial P ( r )}{\partial r} .$$

In particular, FIG. 2A shows a plot of P(rₓ) which is the additional optical power addition P profile as a function of distance rₓ from the optical center OC, on/along the horizontal meridian (HM in FIGS. 1A-1C), in the nasal and temporal directions, represented by curve 21. FIG. 2A also shows a plot of P(r_{y}) which is the additional optical power addition P profile as a function of distance r_{y} from the optical center OC on/along the vertical meridian VM in FIGS. 1A-1C, represented by curve 22.

FIG. 2B shows

$$\frac{\partial P ( {r}_{x} )}{\partial {r}_{x}}$$

which is the slope of P(rₓ), represented by curve 23, and

$$\frac{\partial P ( {r}_{y} )}{\partial {r}_{y}}$$

which is the slope of P(r_{y}), represented by curve 24.

The function P(rₓ), i.e., curve 21 shown in FIG. 2A, is symmetrical about r=0 while the function P(r_{y}), i.e., curve 22 shown in FIG. 2B, is non-symmetrical about r=0. In other words, the additional optical power P can be distributed symmetrically with respect to the vertical meridian VM of the ophthalmic lens (10 in FIGS. 1A-1C) and non-symmetrically with respect to the horizontal meridian HM thereof.

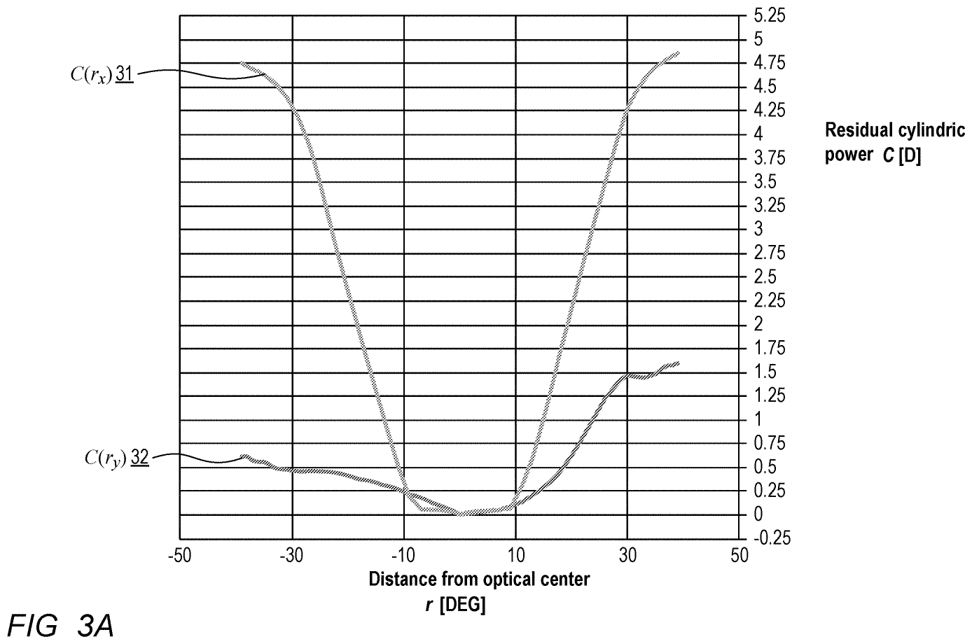

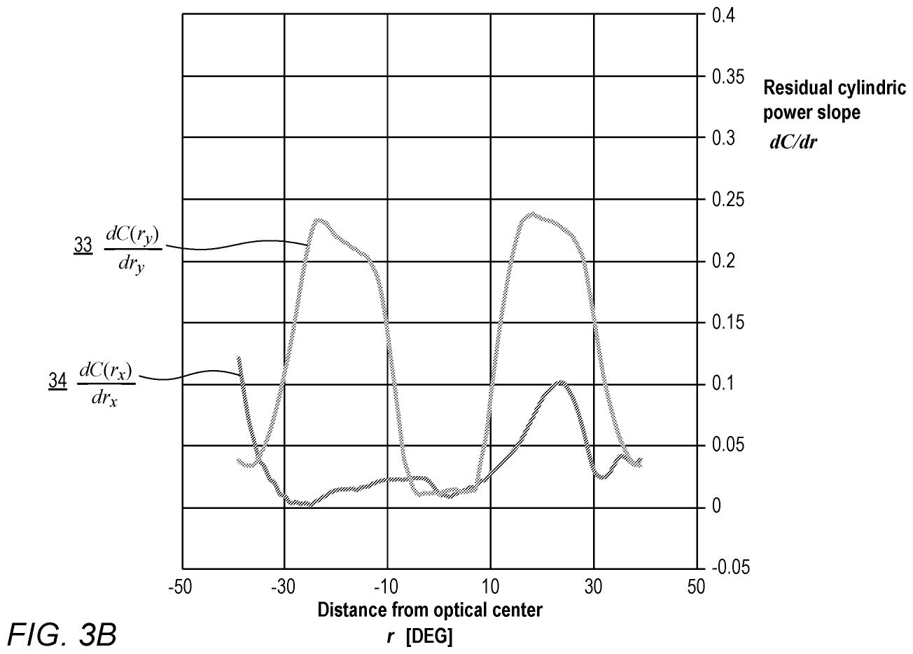

Reference is made to FIGS. 3A and 3B graphically illustrating, respectively, C(r) which is the residual (unwanted) cylinder power C [D] profile as a function of distance r [deg] from the optical center OC of ophthalmic lens 10 of FIGS. 1A-1C and the associated slope (gradient

$$\frac{\partial C ( r )}{\partial r} .$$

More specifically, FIG. 3A shows C(rₓ) being the residual cylinder power C profile as a function of distance rₓ from the optical center OC along/on the horizontal meridian HM in the nasal and temporal directions, represented by curve 31. Also shown in FIG. 3A is C(r_{y}) which is the residual cylinder power C profile as a function of distance r_{y} from the optical center OC along/on the vertical meridian VM, represented by curve 32.

FIG. 3B shows

$$\frac{\partial C ( {r}_{x} )}{\partial {r}_{x}}$$

which is the slope of C(rₓ), represented by curve 33, and

$$\frac{\partial C ( {r}_{y} )}{\partial {r}_{y}}$$

which is the slope of C(r_{y}), represented by curve 34.

As can be seen in FIG. 3A, in the horizontal direction (nasally and temporally), the residual cylinder power C profile is distributed symmetrically with respect to the vertical meridian VM of the ophthalmic lens 10 due to the varying additional optical power along the horizontal meridian HM and non-symmetrical with respect to the horizontal meridian HM. The residual cylinder power remains below 0.5[D] between about −11° and 12° (about 10-12 mm) in the horizontal direction (curve 31) and between about −35° and 20° (about 27 mm) in the vertical direction (curve 32), corresponding to the area of the vertical canal (12 in FIGS. 1B and 1C) which is substantially free of distortions, as residual cylinder power below 0.5[D] is not considered clinically significant for the human eye. Therefore, the vertical canal is considered to be free of distortions.

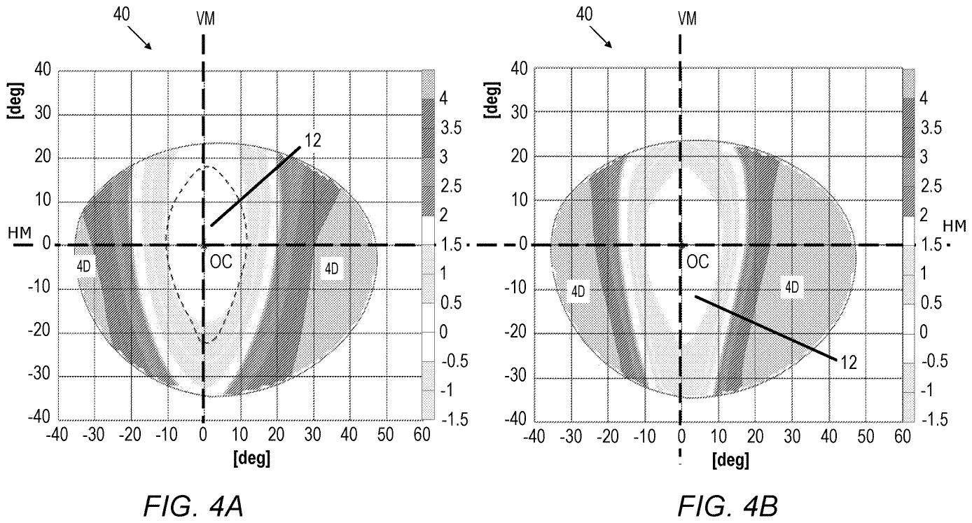

Reference is made to FIGS. 4A and 4B showing, respectively, an optical power addition distribution map (FIG. 4A) and a residual cylinder power distribution map (FIG. 4B) of an ophthalmic lens 40 according to some possible embodiments of the presently disclosed subject matter. The ophthalmic lens 40 has the same design concept as the ophthalmic lens 10 of FIGS. 1A-1C however, in the ophthalmic lens 40, the maximal additional optical power reaches 4.00[D] at the nasal and temporal peripheries thereof, at about 15 mm from the optical center OC along the horizontal meridian HM. The higher addition of 4.00[D] introduces enhanced myopic defocus at the peripheral region(s) of the retina of the eye.

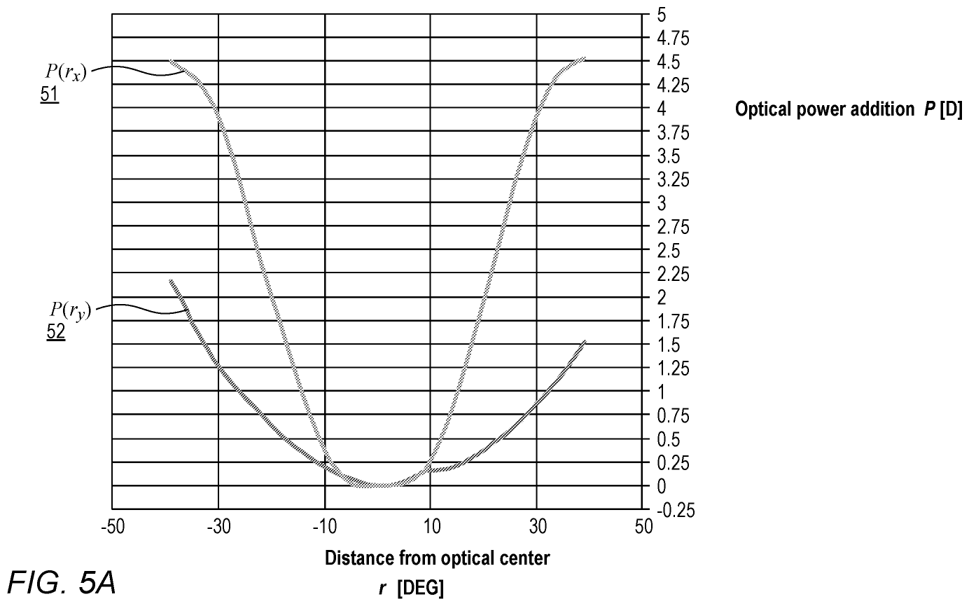

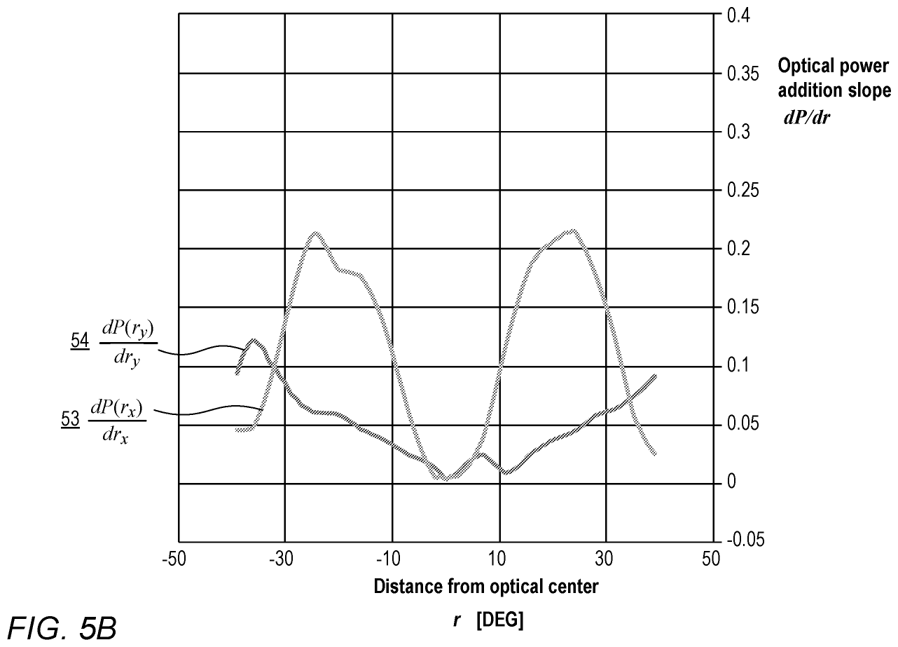

Reference is made to FIGS. 5A and 5B graphically illustrating, respectively, P(r) being the additional optical power P [D] profile as a function of distance r [deg] from the optical center OC of the ophthalmic lens 40 of FIGS. 4A and 4B, and the associated slope

$$\frac{\partial P ( r )}{\partial r} .$$

In particular, FIG. 5A is a plot of P(rₓ) being the additional optical power addition P profile as a function of distance rₓ from the optical center OC along the horizontal meridian HM in the nasal and temporal directions, represented by curve 51. Also shown in FIG. 5A is a plot for P(r_{y}) being the additional optical power addition P profile as function of distance r_{y} from the optical center OC on/along the vertical meridian VM, represented by curve 52.

FIG. 5B shows a plot for

$$\frac{\partial P ( {r}_{x} )}{\partial {r}_{x}}$$

which is the slope of P(rₓ), represented by curve 53, and a plot for

$$\frac{\partial P ( {r}_{y} )}{\partial {r}_{y}}$$

which is the slope of P(r_{y}), represented by curve 54.

The function P(rₓ), i.e., curve 51 shown in FIG. 5A, is symmetrical about r=0 and progressively/gradually reaches about 4D in the nasal and temporal peripheries of the lens 40. The function P(r_{y}), i.e., curve 52 shown in FIG. 5B, is non-symmetrical about r=0. In other words, the additional optical power P can be distributed symmetrically with respect to the vertical meridian VM of the ophthalmic lens (40 in FIGS. 4A and 4B) and non-symmetrically with respect to the horizontal meridian HM thereof.

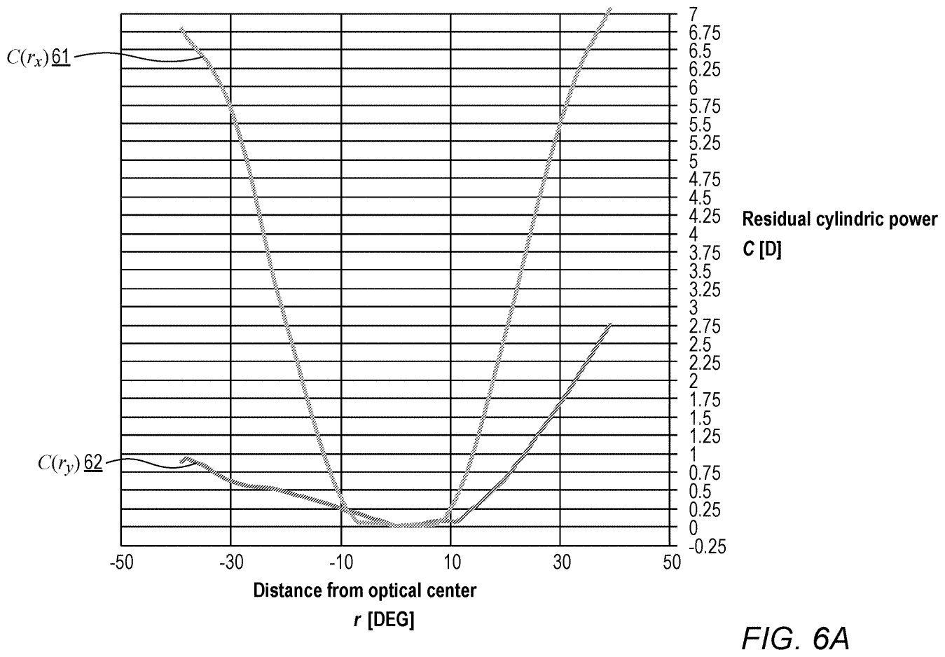

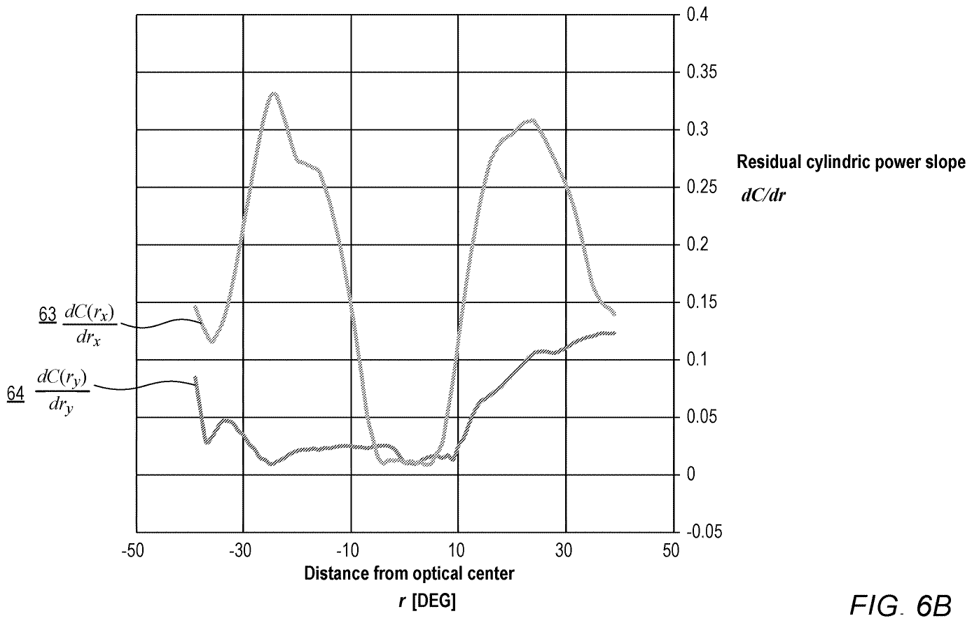

Reference is made to FIGS. 6A and 6B graphically illustrating, respectively, C(r) being the residual (unwanted) cylinder power C [D] profile as a function of distance r [deg] from the optical center (OC in FIGS. 4A-4B) of the ophthalmic lens 40 of FIGS. 4A and 4B and the associated slope

$$\frac{\partial C ( r )}{\partial r} .$$

More specifically, FIG. 6A shows a plot for C(rₓ) which is the residual cylinder power C profile as a function of distance rₓ from the optical center OC along/on the horizontal meridian HM in the nasal and temporal directions, represented by curve 61. Also shown in FIG. 6A is a plot for C(r_{y}) which is the residual cylinder power C profile as function of distance r_{y} from the optical center OC along/on the vertical meridian VM, represented by curve 62.

FIG. 6B shows a plot for

$$\frac{\partial C ( {r}_{x} )}{\partial {r}_{x}}$$

which is the slope of C(rₓ), represented by curve 63, and

$$\frac{\partial C ( {r}_{y} )}{\partial {r}_{y}}$$

which is the slope of C(r_{y}), represented by curve 64.

As can be seen in FIG. 6A, in the nasally and temporally horizontal directions, the residual cylinder power C is distributed symmetrically with respect to the vertical meridian VM of the ophthalmic lens 40 due to the varying additional optical power along the horizontal meridian HM and non-symmetrical along the vertical meridian VM with respect to the horizontal meridian HM thereof. The residual cylinder remains below 0.5[D] between −10° and 11° (about 10-11 mm) in the horizontal direction (curve 31) and between about −20° and 18° (about 19-20 mm) in the vertical direction (curve 32), corresponding to the area of the vertical canal (12 in FIG. 4B) which is substantially free of distortions, as residual cylinder below 0.5 [D] is not considered clinically significance for the human eye.

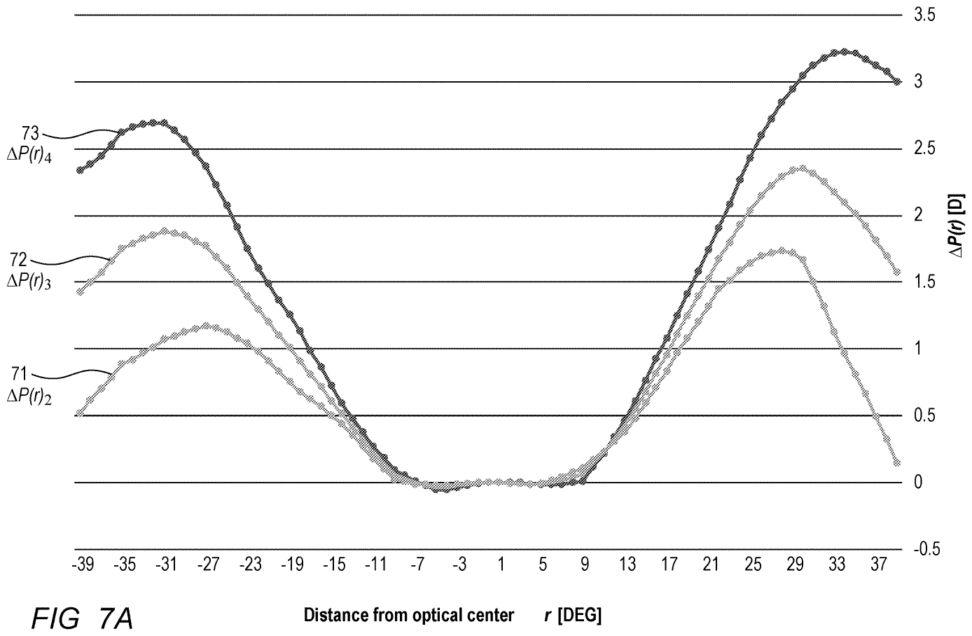

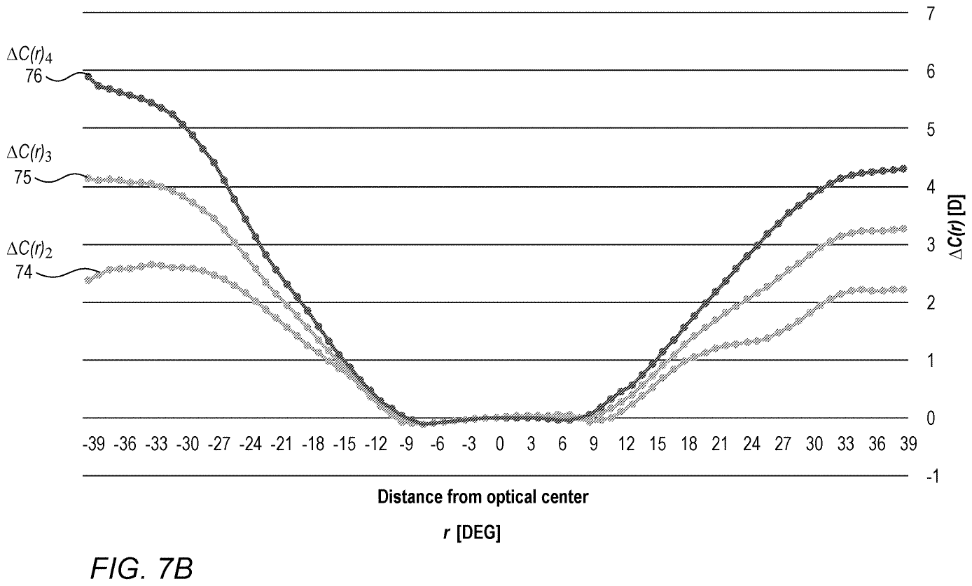

Reference is made to FIGS. 7A and 7B graphically illustrating a comparison of some optical properties for lenses of the present disclosure with different maximal additional optical power. In particular, FIG. 7A shows three plots of additional optical power difference ΔP(r) between the horizontal and vertical meridians associated with each of these lenses. The addition power difference ΔP(r) is denoted by:

$$Δ P ( r ) = P ( {r}_{x} ) - P ( {r}_{y} )$$

whereby P(rₓ) is the additional optical power along the horizontal meridian HM and P(r_{y}) is the additional optical power along the vertical meridian VM. More specifically, curves 71, 72, and 73 represent ΔP(r)₂, ΔP(r)₃, ΔP(r)₄ of lenses with a maximal additional optical power of +2.00[D], +3.00 [D] and +4.00 [D], respectively.

FIG. 7B shows three plots of residual cylinder power difference ΔC(r) between the horizontal and vertical meridians. The cylinder power difference ΔC(r) is denoted by:

$$Δ C ( r ) = C ( {r}_{x} ) - C ( {r}_{y} )$$

whereby C(rₓ) is the residual cylinder power along the horizontal meridian HM and C(r_{y}) is the residual cylinder power along the vertical meridian VM. More specifically, curves 74, 75, and 76 represent ΔC(r)₂, ΔC(r)₃, ΔC(r)₄ of the lenses with the maximal additional optical power of +2.00 [D], +3.00 [D] and +4.00 [D], respectively.

As can be seen in the FIGS. 7A and 7B, a greater maximal optical additional power creates a steeper rise in the additional optical power difference ΔP(r) between the horizontal and vertical meridians (FIG. 7A). Accordingly, since the residual cylinder is associated with the gradual rise of the additional optical power, a greater maximal optical additional power gives rise to a greater maximal cylinder. The rise in the maximal cylinder creates a steeper difference ΔC(r) between the horizontal and vertical meridians (FIG. 7B).

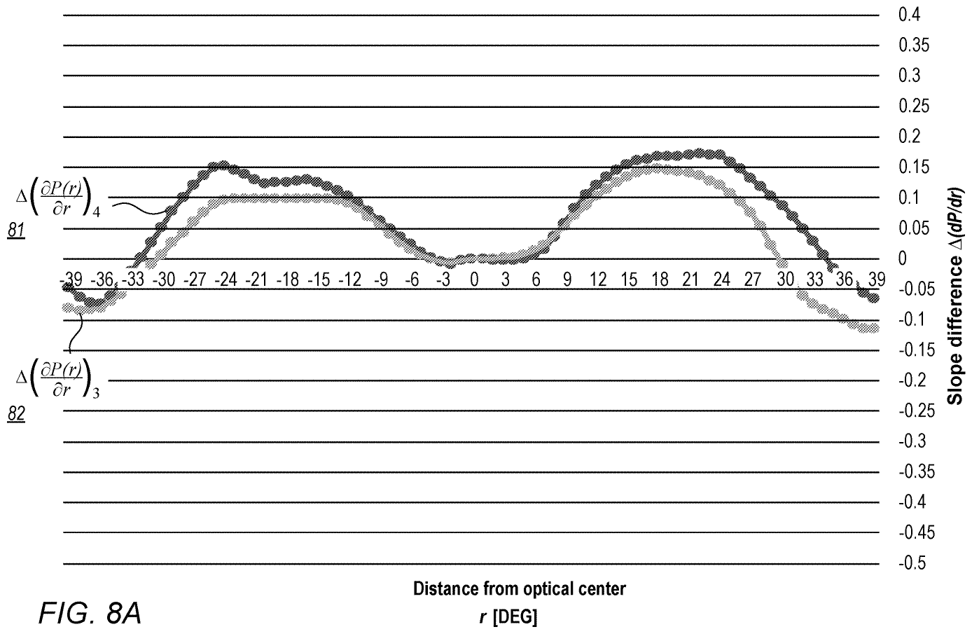

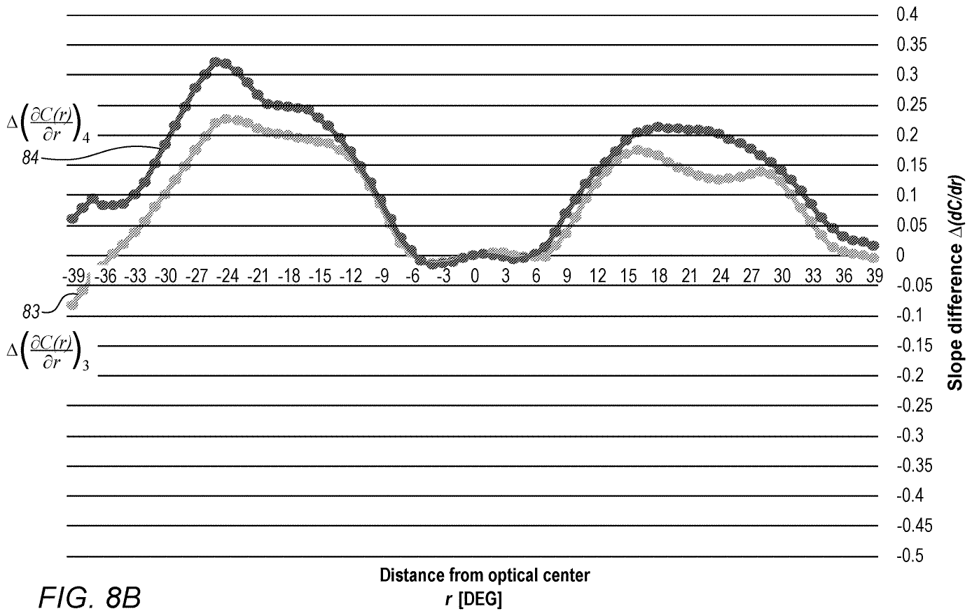

Reference is made to FIGS. 8A and 8B graphically illustrating a comparison of slope differences for two of the lenses of FIGS. 7A and 7B. In particular, FIG. 8A shows two plots of additional optical power slope difference

$$Δ ( \frac{\partial P ( r )}{\partial r} )$$

between the horizontal and vertical meridians associated with each these lenses. The slope difference

$$Δ ( \frac{\partial P ( r )}{\partial r} )$$

is denoted by:

$$Δ ( \frac{\partial P ( r )}{\partial r} ) = \frac{\partial P ( {r}_{x} )}{\partial {r}_{x}} - \frac{\partial P ( {r}_{y} )}{\partial {r}_{y}}$$

whereby

$$\frac{\partial P ( {r}_{x} )}{\partial {r}_{x}} and \frac{\partial P ( {r}_{y} )}{\partial {r}_{y}}$$

are the slopes of the additional power functions P(rₓ) and P(r_{y}), respectively. In particular, curves 81 and 82 represent slope difference

$$Δ {( \frac{\partial P ( r )}{\partial r} )}_{3} and Δ {( \frac{\partial P ( r )}{\partial r} )}_{4}$$

of lenses with maximal additional optical power of +3.00 [D] and +4.00 [D], respectively.

FIG. 8B shows a comparison of residual cylinder power slope differences

$$Δ ( \frac{\partial C ( r )}{\partial r} )$$

between the horizontal and vertical meridians associated with each of these lenses. The slope difference

$$Δ ( \frac{\partial C ( r )}{\partial r} )$$

is denoted by:

$$Δ ( \frac{\partial C ( r )}{\partial r} ) = \frac{\partial C ( {r}_{x} )}{\partial {r}_{x}} - \frac{\partial C ( {r}_{y} )}{\partial {r}_{y}}$$

whereby

$$\frac{\partial C ( {r}_{x} )}{\partial {r}_{x}} and \frac{\partial C ( {r}_{y} )}{\partial {r}_{y}}$$

are the slopes of the residual cylinder power functions C(rₓ) and C(r_{y}), respectively. In particular, curves 83 and 84 represent slope difference

$$Δ {( \frac{\partial C ( r )}{\partial r} )}_{3} and Δ {( \frac{\partial C ( r )}{\partial r} )}_{4}$$

of the aforementioned lenses with the maximal additional optical power of +3.00 [D] and +4.00 [D], respectively.

As can be seen in the figures, a greater maximal optical additional power creates a sharper rise in the additional optical power slope difference

$$Δ ( \frac{\partial P ( r )}{\partial r} )$$

between the horizontal and vertical meridians (FIG. 8A) and consequently also creates a sharper residual cylinder slope difference

$$Δ ( \frac{\partial C ( r )}{\partial r} )$$

between the horizontal and vertical meridians (FIG. 8B).

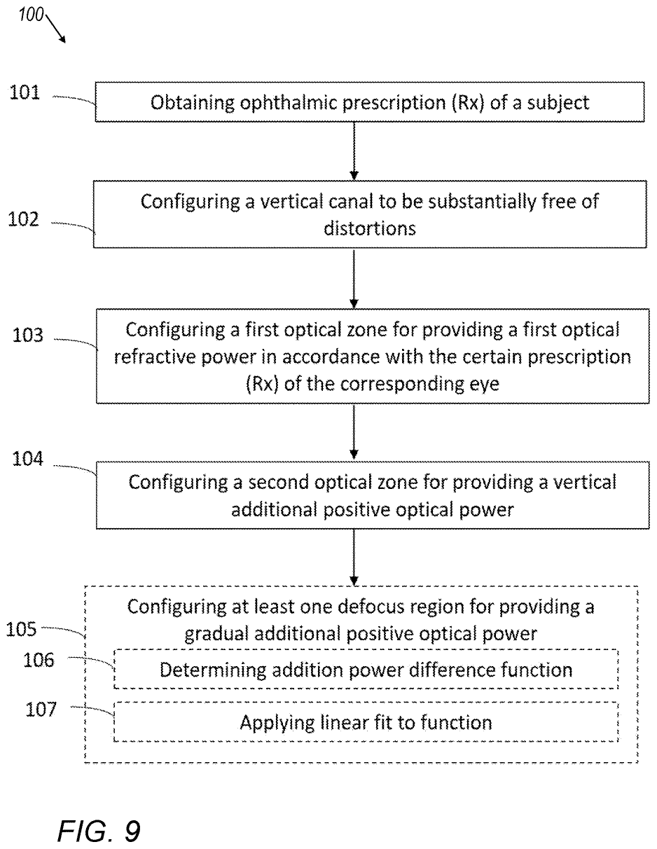

Reference is made to FIG. 9, showing a functional flow chart of a method 100 for designing at least one ophthalmic lens for affecting the progression of myopia in an eye of an individual. Method 100 may include the optional step of obtaining in 101, an ophthalmic prescription (Rx) of a subject/individual. Method 100 comprises configuring in 102 a vertical canal to be substantially free of distortions. The vertical canal can have a bottom apex defining a substantially U-shape and can extend along a vertical meridian of the ophthalmic lens to at least one of bottom and top boundaries thereof; Configuring in 103 a first optical zone for providing a vertical optical refractive power in accordance with the certain prescription (Rx) of the corresponding eye. The first optical zone can be accommodated about the optical center of the at least one ophthalmic lens and can extend to a top boundary thereof and configuring in 104 a second optical zone for providing a vertical additional optical power. The second optical zone can be located at the bottom apex of the vertical canal below the first optical zone.

In some embodiments the method 100 can further include configuring in 105 at least one defocus region at least partially surrounding the first optical zone for providing a gradual additional optical power. The at least one defocus region can substantially extend from the edges of the vertical canal and gradually vary in a temporal and nasal directions to focus far images in front of the nasal peripheral retina and/or the temporal retina respectively and to minimize peripheral hyperopic defocus. The gradual additional optical power can reach a predefined maximal value at a predefined distance from the optical center of the at least one ophthalmic lens.

In some embodiments, configuring the at least one defocus region in 105 comprises determining in 106, a function being indicative of a difference between the additional optical power along a vertical and horizontal meridian of the ophthalmic lens. This may be implemented by applying in 107, linear fitting to the function being indicative of the difference between the additional optical power along the vertical and horizontal meridians of the ophthalmic lens. For example, linear threads being indicative of a relation (difference) between the horizontal and vertical power profiles (i.e., the additional optical power along the vertical and horizontal meridians), may be calculated. The linear threads can be utilized for designing the ophthalmic lens in accordance with the prescription of the subject.

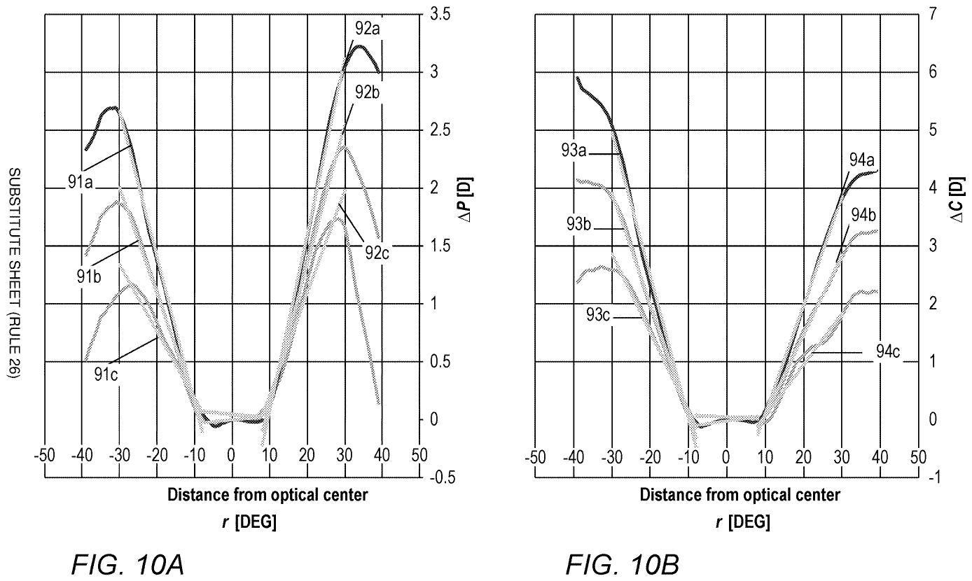

In this connection, reference is made to FIGS. 10A and 10B graphically illustrating a linear fit of the curves shown in FIGS. 7A and 7B, respectively. In particular, in FIG. 10A, linear threads 91a-91c corresponds to the general equation y=a₁x+b₁ whereby a₁ can be in the range of −0.05 to −0.13 and b₁ can be in the range of −1.11 to −0.39, linear threads 91a-91c. Linear trends 92a-92c corresponds the general equation to y=a₂x+b₂ whereby a₂ can be in the range of 0.08 to 0.16 and b₂ can be in the range of −0.67 to −1.43. In FIG. 10B, linear trends 93a-93c corresponds to the general equation y=a₃x+b₃ whereby a₃ can be in the range of −0.25 to −0.13 and b₃ can be in the range of −2.47 to −1.2. Linear trends 94a-94c correspond to the general equation y=a₄x+b₄ whereby a₄ can be in the range of 0.08 to 0.19 and b₄ can be in the range of −1.75 to −0.8. It should be noted that the general equations y=a₁x+b₁ and y=a₂x+b₂ may also correspond to linear trends of various lenses having maximal additional power between 2D and 4D while general equations y=a₃x+b₃ and y=a₄x+b₄ may correspond to the residual cylinder power difference associated with these lenses.

These linear trends can be used to determine an optical profile. For example, for a subject with a prescription −4.00 [D] sph, using the corresponding linear threads shown in FIGS. 10A and 10B an optical power profile can be determined, wherein the first optical zone includes the prescription of −4.00 [D] sph and the defocus regions zone provides an additional optical power gradually varying up to 0.5 in a temporal and nasal directions up to about 12 deg, gradually varying from 0.5 to 1.5 in a temporal and nasal directions from 10 deg to 20 deg, gradually varying from 1.5 to 3 in a temporal and nasal directions from 20 deg to 30 deg, according to the linear trends defined above.

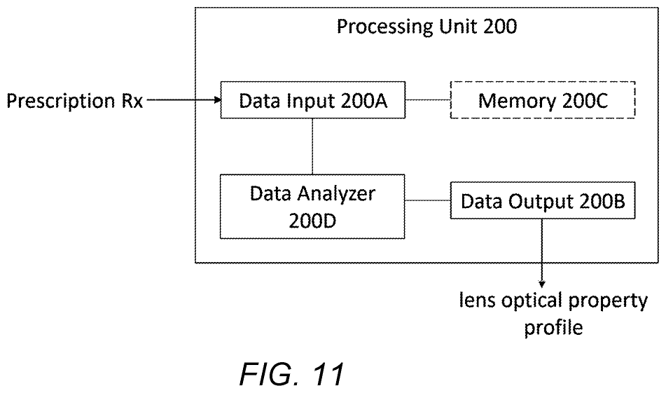

Reference is made to FIG. 11, showing a functional block diagram of a processing unit 200 for providing an individualized lens optical property profile. In general, processing unit 200 may be a processor, a controller, a microcontroller, or any kind of integrated circuit. Control unit 200 is configured generally as a computing/electronic utility including inter alia such utilities as a data input utility 200A, a data analyzer 200D, and a data output utility 200B and may further include or be associated with a memory 200C (i.e., a non-volatile computer-readable medium) for storing the input/output data, a database, or the computer program. The processor unit may be a processing circuitry. The processing circuitry may be implemented as a central processing unit (CPU) and/or a graphics processing unit (GPU), and/or one or more other integrated circuits such as application-specific integrated circuits (ASICs), field programmable gate arrays (FPGAs), full-custom integrated circuits, or a combination of such integrated circuits. A computerized system may include one or more processors and may also include additional units or components such as memory units, communication units, and the like. The database may be a cloud-based system. In an example, the cloud-based system may be a distributed blockchain system, wherein a number of parties (e.g., manufacturer, recycler, retailer) have access to the distributed ledger. The latter is a type of Internet-based computing that provides shared computer processing resources and data (such as servers, storage, and applications) to computers and other devices through the computer network (or communication network), such as the Internet. Cloud computing and storage solutions provide users and enterprises with various capabilities to store and process their data in either privately owned or third-party data centers that may be located far from the user-ranging in distance from across a city to across the world. Thus, the present disclosure provides for using the cloud computing technique, according to which a central data analyzer (software) is used to receive the sensing data from multiple products' storage locations and using these multiple data sources for optimizing the above-mentioned identification of the product types and product status monitoring (e.g. utilizing self-learning modes, models' optimization, etc.).

Memory 200C may be integrated within processing unit 200 or may be an external storage device accessible by processing unit 200. The software may be downloaded to processing unit 200 in electronic form, over a network, for example, or it may alternatively be provided on tangible media, such as optical, magnetic, or electronic memory media. The computer program described above may be intended to be stored in memory 200C, or in a removable memory medium adapted to cooperate with a reader of the processing unit 200, comprising instructions for implementing the method as will be described below. More specifically, the computer program may be in communication with an interface to receive order and time data.

Unless specifically stated otherwise, as apparent from the following discussions, it is appreciated that throughout the specification discussions utilizing terms such as “determining”, “processing” or the like, refer to the action and/or processes of a computer that manipulates and/or transforms data into other data. Also, operations in accordance with the teachings herein may be performed by a computer specially constructed for the desired purposes, or by a general-purpose computer specially configured for the desired purpose by a computer program stored in a computer-readable storage medium.

The data input utility 200A is configured and operable to receive a certain prescription (Rx), a handedness of an individual. The data input utility 400A may comprise a communication interface being appropriately configured for connecting the data analyzer 200D, via wires or wireless signal transmission (e.g., via communication network(s)), to either a measurement module supplying the parameters mentioned above or to external memory (database) where such data have been previously stored. The communication interface may be a separate utility from processing unit 200 or may be integrated therewithin. When the communication interface is a separate unit from processing unit 200, processing unit 200 may comprise a transceiver permitting it to be connected to the communication interface and to transmit and/or receive data. When the communication interface is integrated within processing unit 200, it may be included in the data input utility 200A and the data output utility 200B of processing unit 200.

The data analyzer 200D is configured and operable to determine an additional optical power gradually varying in a temporal and nasal directions. The data analyzer 200D may also be adapted for: (i) configuring a vertical canal to be substantially free of distortions and to include to have optical power according to Rx prescription (ii) configuring defocus regions with additional gradual power.

The data output utility 200B is configured and operable to provide a lens optical property profile defining a (i) a vertical canal being substantially free of distortions extending from the optical center of the lens to at least one of bottom and top boundaries thereof and including a first optical zone having an optical correction according to the Rx of the eye and a second optical zone for providing a vertical additional optical power and defocus regions for providing an additional gradual optical power.

The utilities of the processing unit 200 may thus be implemented by suitable circuitry and/or by software and/or hardware components including computer readable code configured for receiving a calculated optical design profile being indicative of a specific patient's correction, the optical properties of the defocus regions and for processing the data to generate a physical representation data of the optical property profile. The features of the present disclosure may include a general-purpose or special-purpose computer system including various computer hardware components. Features within the scope of the present disclosure also include computer-readable media for carrying out or having computer-executable instructions, computer-readable instructions, or data structures stored thereon. Such computer-readable media may be any available media, which are accessible by a general-purpose or special-purpose computer system. In this description and the following claims, a “processing unit” is defined as one or more software modules, one or more hardware modules, or combinations thereof, which work together to perform operations on electronic data. The physical layout of the modules is not relevant. The processing unit 200 may be configured as an electronic module for collecting, processing data, and optionally sending instructions to a system being capable of creating the optical property profile. In some embodiments, processing unit 200 is configured and operable to calculate an optical design profile being indicative of a specific patient's correction.

The term “processing unit” should be expansively construed to cover any kind of electronic device with data processing capabilities, including, by way of non-limiting example, personal computers, servers, computing systems, communication devices, processors (e.g. digital signal processor (DSP), microcontrollers, field programmable gate array (FPGA), application specific integrated circuit (ASIC), etc.) and other electronic computing devices. The control unit may comprise a general-purpose computer processor, which is programmed in software to carry out the functions described hereinbelow. Also, operations in accordance with the teachings herein may be performed by a computer specially constructed for the desired purposes or by a general-purpose computer specially configured for the desired purpose by a computer program stored in a computer-readable storage medium. The different elements of the processing unit (electronic unit and/or mechanical unit) are connected to each other by wires or are wireless. The software may be downloaded to the processing utility in electronic form, over a network, for example, or it may alternatively be provided on tangible media, such as optical, magnetic, or electronic memory media. Alternatively, or additionally, some or all of the functions of the processing unit may be implemented in dedicated hardware, such as a custom or semi-custom integrated circuit, or a programmable digital signal processor (DSP).

The terms “control unit” and “processor utility” are used herein interchangeably and refer to a computer system, state machine, processor, or the like, designed to perform arithmetic or logic operations using logic circuitry that responds to and processes the instructions that drive a computer. The techniques and system of the presently disclosed subject matter can find applicability in a variety of computing or processing environments, such as a computer or process-based environments. The techniques may be implemented in a combination of software and hardware. The techniques may be implemented in programs executing on programmable machines such as stationary computers being configured to obtain raw log data, as has also been described above.

Program code is applied to the data entered using the input device to perform the techniques described and to generate the output information. The output information can then be applied to one or more output devices. Each program may be implemented in a high-level procedural or object-oriented programming language to communicate with a processed-based system. However, the programs can be implemented in assembly or machine language, if desired.

In other embodiments, the technique of the presently disclosed subject matter can be utilized over a network computing system and/or environment. Several computer systems may be coupled together via a network, such as a local area network (LAN), a wide area network (WAN), or the Internet. Each method or technique of the presently disclosed subject matter as a whole or a functional step thereof could be thus implemented by a remote network computer or a combination of several. Thus, any functional part of processing unit 200 can be provided or connected via a computer network. In addition, the control unit can also remotely provide processor services over a network. Each such program may be stored on a storage medium or device, e.g., compact disc read-only memory (CD-ROM), hard disk, a magnetic diskette, or similar medium or device, that is readable by a general or special purpose programmable machine for configuring and operating the machine when the storage medium or device is read by the computer to perform the procedures described in this document. The system may also be implemented as a machine-readable storage medium, configured with a program, where the storage medium so configured causes a machine to operate in a specific and predefined manner.

Relative terms such as “lower,” “upper,” “horizontal,” “vertical,” “above,” “below,” “up,” “down,” “top” and “bottom”, as well as derivatives thereof (e.g., “horizontally,” “downwardly,” “upwardly,” etc.), and similar adjectives in relation to the orientation of the described elements/components refer to the manner in which the illustrations are positioned on the paper, not as any limitation to the orientations in which these elements/components can be used in actual applications.

It should also be understood that throughout this disclosure, where a process or method is shown or described, the steps/acts of the method may be performed in any order and/or simultaneously, and/or with other steps/acts not illustrated/described herein unless it is clear from the context that one step depends on another being performed first. In possible embodiments, not all of the illustrated/described steps/acts are required to carry out the method.

1. An ophthalmic lens for affecting progression of myopia in an eye of an individual having a certain prescription (Rx), the lens comprising an optical power profile defining:
(i) a vertical canal having a bottom apex defining a substantially U-shape extending along a vertical meridian of the ophthalmic lens to at least one of bottom and top boundaries thereof, said vertical canal being substantially free of distortions; wherein the vertical canal comprises a first optical zone accommodated around the optical center of the ophthalmic lens and extending to a top boundary thereof, said first optical zone being configured for providing a first optical refractive power in accordance with the certain prescription (Rx); and a second optical zone located at the bottom apex of the vertical canal;
(ii) at least one defocus region at least partially surrounding the first optical zone of the vertical canal and being configured for providing a defocus additional optical power substantially extending from edges of the vertical canal and gradually varying in a temporal and nasal directions enabling to focus far images in front of the nasal peripheral retina and/or on the temporal peripheral retina respectively and to minimize peripheral hyperopic defocus; wherein said at least one defocus region comprises said second optical zone of the vertical canal;
such that the ophthalmic lens is configured to: correct myopia associated with the foveal region of the retina of the wearer, and effect myopic defocus in the peripheral region of the retina of the wearer, for affecting the growth of the eye of the wearer, thereby controlling the progression of myopia in the eye of the wearer.

2. The ophthalmic lens of claim 1, wherein the defocus additional optical power is distributed symmetrically with respect to a vertical meridian of the ophthalmic lens and non-symmetrically with respect to a horizontal meridian thereof.

3. The ophthalmic lens of claim 1 or claim 2, wherein the vertical canal is symmetrical with respect to the vertical meridian of the ophthalmic lens and non-symmetrical with respect to the horizontal meridian thereof.

4. The ophthalmic lens of any one of claims 1 to 3, wherein the first optical zone comprises an additional optical refractive power having a minimum value of about 0.01 [D] at about a 1 mm radius and an increase of about 0.1 D at about 2-3 mm radius and increase to about 0.5 D from the certain prescription (Rx) in the horizontal directions in the range of about 5-6 mm from the optical center.

5. The ophthalmic lens of any one of claims 1 to 4, wherein the vertical canal is configured to horizontally extend to about 5 mm from each side of the optical center and to vertically extend to about 10 mm above the optical center.

6. The ophthalmic lens of any one of claims 1 to 5, wherein the vertical canal comprises an area delimited by a contour of about 0.5[D] residual cylinder power extending horizontally and vertically.

7. The ophthalmic lens of claim 6, wherein the residual cylinder power reaches a value of about 0.5 [D] at about 15-16 mm below the optical center along the vertical meridian.

8. The ophthalmic lens of any one of claims 1 to 7, wherein the vertical and defocus additional optical powers are distributed symmetrically with respect to the vertical meridian of the ophthalmic lens and non-symmetrically with respect to the horizontal meridian thereof.

9. The ophthalmic lens of claim 8, wherein a maximal defocus additional optical power has a constant maximum value being not dependent on the individual and being not related to the vertical additional optical power.

10. The ophthalmic lens of claims 1 to 9, wherein the defocus additional optical power reaches a value of about 0.5 [D] at a radial distance in the range of about 5-6 mm from the optical center along a horizontal meridian.

11. The ophthalmic lens of any one of claims 1 to 10, wherein the vertical additional optical power reaches a value of about 0.5 [D] at a radial distance in the range of about 10 mm below the optical center along a vertical meridian.

12. The ophthalmic lens of any one of claims 1 to 11, wherein the vertical additional optical power reaches a value in the range of about 0.50-1.00 [D] at a radial distance of about 9-15 mm below the optical center along a vertical meridian.

13. The ophthalmic lens of any one of claims 1 to 12, wherein the defocus additional optical power reaches a value of about 2.5 [D] at a radial distance of about 25 deg from the optical center along a horizontal meridian.

14. The ophthalmic lens of any one of claims 1 to 13, wherein the defocus additional optical power reaches a value of about 3 [D] at a radial distance in the range of about 30-35 deg from the optical center along the horizontal meridian.

15. The ophthalmic lens of any one of claims 1 to 14, wherein said optical power profile is carried out by a back surface of the lens.

16. A method for designing at least one ophthalmic lens for affecting progression of myopia, the method comprising:
obtaining an ophthalmic prescription of a subject;
configuring a vertical canal to be substantially free of distortions having a bottom apex defining a substantially U-shape and extending along a vertical meridian of the at least one ophthalmic lens to at least one of bottom and top boundaries thereof having a first optical zone for providing a first optical refractive power in accordance with the certain prescription (Rx) of the corresponding eye, said first optical zone being accommodated about the optical center of the at least one ophthalmic lens and extending to a top boundary thereof and a second optical zone for providing a vertical additional optical power, said second optical zone being located at the bottom apex of the vertical canal;
configuring at least one defocus region at least partially surrounding the first optical zone for providing a defocus additional optical power substantially extending from edges of the vertical canal and gradually varying in a temporal and nasal directions along the horizontal meridian to focus far images in front of the nasal peripheral retina and/or the temporal retina respectively and to minimize peripheral hyperopic defocus, wherein said defocus additional optical power reaches a predefined maximal value at a predefined distance from the optical center of the at least one ophthalmic lens.

17. The method of claim 16, further comprising measuring a certain prescription (Rx) of at least one eye.

18. The method of claim 16 or claim 17, wherein the configuring the at least one defocus region comprises determining a function being indicative of a difference between the additional optical power along vertical and horizontal meridians of the ophthalmic lens.

19. The method of claim 18, wherein the determining of the additional optical power further comprises applying linear fitting to the function being indicative of the difference between the additional optical power along the vertical and horizontal meridians of the ophthalmic lens.

20. The method of any one of claims 16 to 19, further comprising providing a lens with the vertical canal including the first optical zone and the second optical zone.

21. A processing unit for providing an individualized lens optical property profile, the processing unit comprising a data input utility being configured and operable to receive a certain prescription (Rx) of an individual, a data processing utility being configured and operable to determine an additional optical power gradually varying in a temporal and nasal directions, and a data output utility being configured and operable to provide a lens optical property profile defining a vertical canal being substantially free of distortions extending from the optical center to at least one of top and bottom boundaries thereof and including a first optical zone having an optical correction according to the Rx of the eye, and a second optical zone for providing a vertical additional optical power.
